(19) United States
(12) Patent Application Publication
(10) Pub. No.: US 2003/0158985 A1
(43) Pub. Date: Aug. 21, 2003

(54) Systems and methods for fair arbitration between multiple request signals

(76) Inventor: Edward Fried, Bedminster, NJ (US)

Correspondence Address: Mike Everett, 4695 Cabot, Suite 200, Pleasanton, CA, 94588, US

(21) Appl. No.: 10/078,324

(22) Filed: Feb. 15, 2002

(51) Int. Cl. G06F 13/36

(52) U.S. Cl. 710/113

(57) ABSTRACT

A reprogrammable architecture for an arbiter is described. The arbiter is designed to be fair, fast, and simple to implement in circuitry, particularly in programmable logic. In embodiments, the arbiter arbitrates amongst n-many requesters, labeled Requester₀, Requester₁, . . . , Requesterₙ₋₁. The arbiter operates by multiplexing n-many connectors, which enables dynamic reprioritizing of the requests. Thus, n-many connectors, labeled Connector₀ through Connectorₙ₋₁, are bijectively multiplexed to the n-many requesters. The requests from the connectors may then be reprioritized by altering the bijective map from the connectors to the requestors.

### FIELD OF THE INVENTION

The invention relates to the fields of computing and networking, and, more particularly, to arbitration schemes used to select amongst multiple requests.

### DESCRIPTION OF RELATED ART

The issue of selecting amongst request signals is ubiquitous in the electronic, computing, and networking arts, and the prior art is replete with techniques used to arbitrate amongst such signals. Arbiters may be used to allocate bus resources, access to shared memory, networking connections, database transactions; such arbiters may be implemented as hardware circuitry, in programmable logic, or in software running on general purpose CPUs.

Numerous schemes are deployed to arbitrate amongst signals or resources. In many such schemes, the various requesters coupled to the arbiter are rank ordered, so that in the case of a collision between requests, the requester with the highest priority gets preference from the arbiter. In some schemes, the requesters have fixed, static ranks. In others, the rankings are dynamically revised; some such schemes revise the rankings after each request.

Dynamic ranking schemes are frequently cumbersome to implement. For instance, consider a scheme wherein the priority of a set of requesters is governed by a set of if-then-else statements. For instance, suppose an arbiter was defined by the following scheme, presented in pseudo-code below:

If Requester0 then grant(Requester0)

Else if Requester1 then grant(Requester1)

Else if Requester2 then grant(Requester2)

Else if Requester3 then grant(Requester3)

Now suppose the arbiter is dynamic, that is, the priority of the requesters is to be changed dynamically. The code above would have to be altered in order to accommodate the new priority. This would be particularly problematic if the arbiter were implemented in a programmable hardware such as an FPGA, resulting in complex and slow implementation of the arbiter.

### SUMMARY OF THE INVENTION

A reprogrammable architecture for an arbiter is described herein. The arbiter is designed to be fair, fast, and simple to implement in circuitry, particularly in programmable logic. In some embodiments of the invention, the arbiter may be used to arbitrate between numerous bus signals, allocating priority to the various bus signals through a fair scheme.

In some embodiments of the invention, the arbiter arbitrates amongst n-many requesters, which may, for illustrative purposes, be labeled Requester 0, Requester₁, . . . , Requesterₙ₋₁. In some such embodiments, the arbiter may operate by multiplexing n-many connectors, which enables dynamic reprioritizing of the requests. Thus, n-many connectors, labeled Connector₀ through Connectorₙ₋₁, are bijectively multiplexed to the n-many requesters. The requests from the connectors may then be reprioritized by altering the bijective map from the connectors to the requesters.

In some such embodiments, the map from the connectors to the requestors may be altered so that the priority of a requester is to be dropped to the lowest level after it has been granted control by the arbiter. After the grant has lapsed, the bijective map is revised, so that Connector y will map to Requester n−1, and the remaining connectors will be mapped to Requester 0 through Requester n−2 in order to preserve their relative order of priority with one another.

In non-limiting embodiments, the arbiter may be utilized to govern access to a high speed bus in a networking device. For instance, the arbiter may govern access to the high speed bus by POS lines and DMA controllers. In some such embodiments, the high speed bus may take the form of a Low Voltage Differential Signaling bus, operating rates of on, about, or better than 10 Gbps, full-duplex. These and other embodiments are described in further detail herein.

### BRIEF DESCRIPTION OF FIGURES

FIG. 1 illustrates the architecture of an arbiter according to embodiments of the invention.

FIG. 2 illustrates the internal operation of an arbiter according to embodiments of the invention.

FIG. 3 illustrates an example of an arbiter used to govern access to a high speed bus, according to embodiments of the invention.

### DETAILED DESCRIPTION

Embodiments of the invention described herein are presented for purposes of example only, and in no manner limit the scope of the invention. Many alternative and equivalent embodiments will be apparent to those skilled in the art.

Description of Arbiter

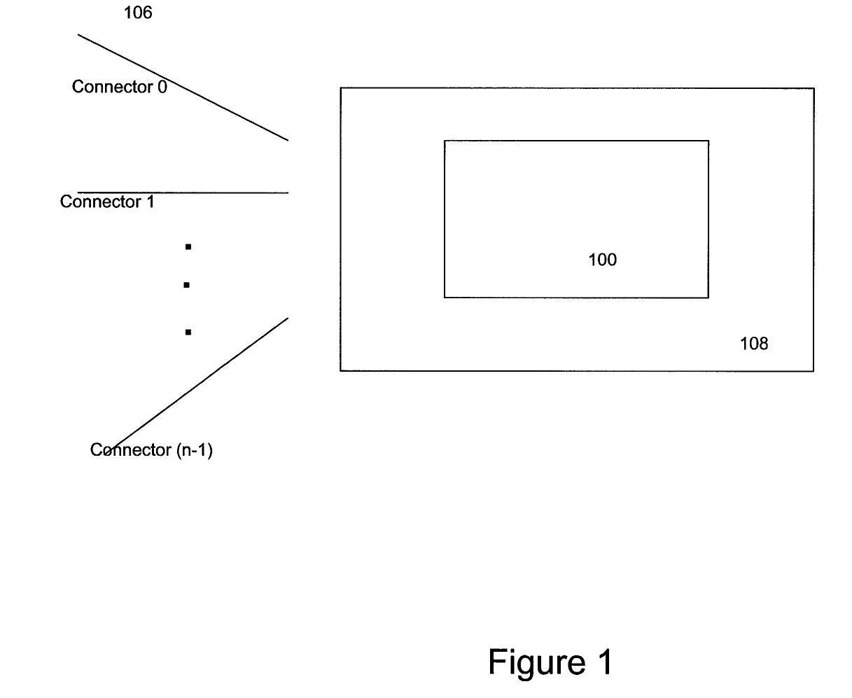

Some embodiments of the invention include an arbiter with a fair weighted arbitration scheme, as illustrated in FIG. 1. In some embodiments, the arbiter 100 may reside in a switcher 108, which couples multiple connectors 106 to a system resource. By way of illustration, the n-many connectors may be labeled Connector₀ through Connectorₙ₋₁. As a non-limiting example, the switcher 108 may be used to arbitrate access to a system bus between the connectors 106. Other resources whose access may be controlled by the switcher 108 and/or arbiter 100 will be apparent to those skilled in the art.

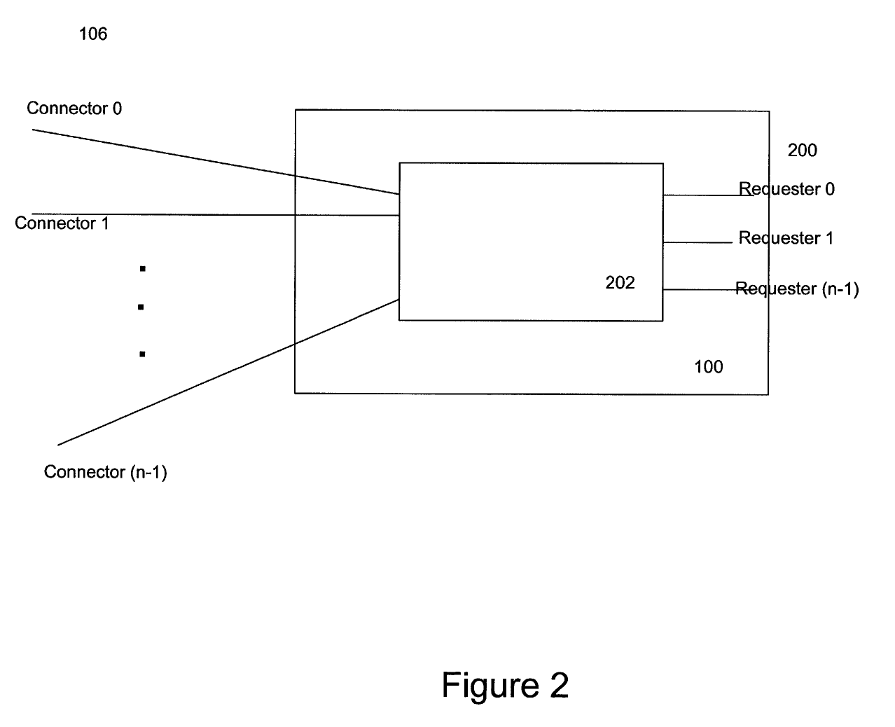

FIG. 2 illustrates the internal operation of the arbiter 100. The arbiter 100 handles n requesters 200, labeled Requester₀, Requester₁, . . . , Requesterₙ₋₁, which allocate priority to the resource which is accessed by the connectors 106 by use of the arbiter 100 and switcher 108. In some embodiments, these requesters 200 have a fixed priority. By way of non-limiting example, the fixed priority may be descending order of priority; this may be expressed in pseudo code as follows:

TABLE 1

If Requester ₀ then Grant(Requester ₀)

Else if Requester ₁ then Grant(Requester ₁)

. . .

Else if Requester ₙ₋₁ then Grant(Requester ₙ₋₁)

In some embodiments, the arbiter also includes a multiplexer, or mux 202, which enables dynamic reprioritizing of the requests from the connectors 106. During operation, the mux 202 bijectively maps n-many connectors 106, labeled Connector₀ through Connectorₙ₋₁ to the n-many requesters 200. Thus, the requests from the connectors 106 are reprioritized by use of the mux 204, which remaps the multiplexed connection between the connectors 106 and the requestors 200.

Operation of Fair Weighted Arbiter

The operation of the arbiter 100 may be illustrated by example. Suppose the relative priorities of the requesters 200 are to be revised dynamically. By way of non-limiting example, suppose priorities are revised after each grant, and the priority of a requester is to be dropped to the lowest level after it has been granted control by the arbiter 100. For instance, suppose Requesterₓ {(x≦n), and, without loss of generality, x<>(n−1)}, wins the grant in the current clock cycle, and that Requesterₓ was coupled to Connector_{y}. After the grant has lapsed, the bijective map in the mux 202 shall be revised, so that Connector_{y} will map to Requesterₙ₋₁, and the remaining connectors 106 will be mapped to Requester₀ through Requesterₙ₋₂ in order to preserve their relative order of priority with one another. Using an arbiter as described herein, all n! possible prioritization of the Connectors 106 can be realized.

Use of Fair Weighted Arbiter in Programmable Hardware

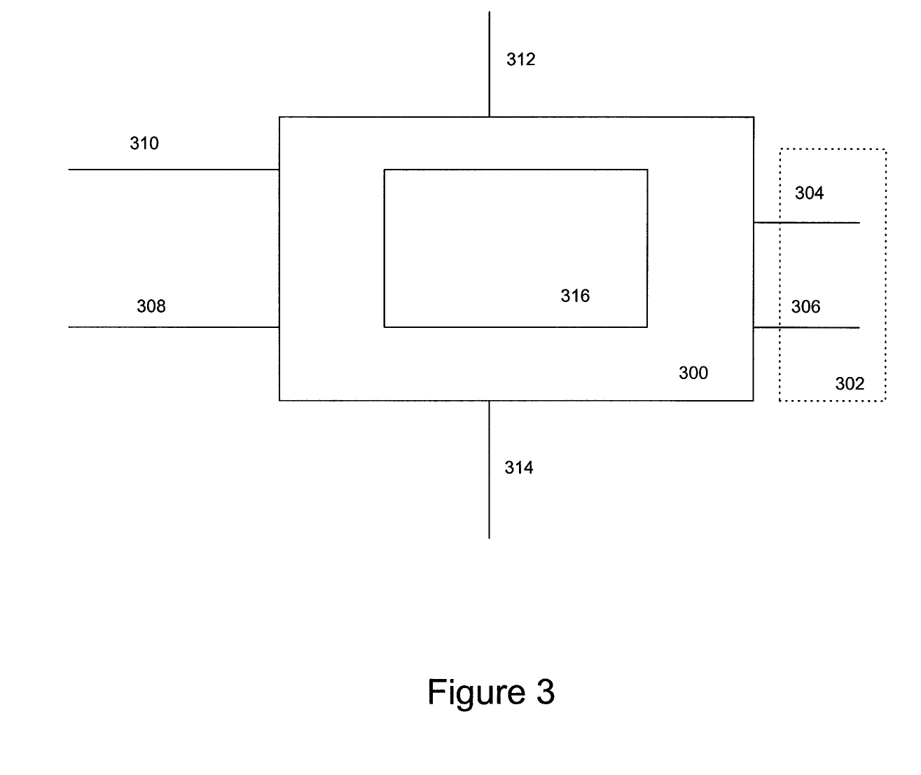

An example of an instantiation of the arbiter 100 described herein is illustrated in FIG. 3. The figure includes a switcher 300; as a non-limiting example, the switcher may be used in a high speed backplane in a networking device, as described in as described in U.S. application Ser. No. 09/679,321, filed Oct. 3, 2000, inventors Junaid Islam, Homayoun Valizadeh, and Jeffery S. Payne, and U.S. Ser. No. 09/918,363, filed Jul. 30, 2001, inventors Junaid Islam, Homayoun Valizadeh, and Jeffery S. Payne, which are hereby incorporated by reference in their entirety. In some such examples, the switcher 300 may be implemented on a Field Programmable Gate Array (FPGA), other programmable hardware, or ASIC (in the example of FPGAs, the switcher may be implemented as code in a high-level design language, such as, by way of non-limiting example, Verilog or VHDL). Other examples will be apparent to those skilled in the art.

In the example illustrated in FIG. 3, the switcher 300 governs access to a high speed stack bus 302. In embodiments of the invention, the high speed bus 302 includes two Low Voltage Differential Signaling (LVDS) buses 304 306. In the example illustrated, each of the LVDS lines 304 306 may have 16 pins, which operate at rates of 622 MHz, thus resulting in a total bandwidth for each line 304 306 of:

622 Mhz*(1 bit,full-duplex/pin)*16 pins=9.952 Gbps, full-duplex

FIG. 3 also illustrates four additional connector lines, including a CPU line 308 coupling the switcher 300 to a CPU controller. As a non-limiting example, the controller may be a 32 bit DMA controller, such as one produced by Gallileo™ Inc. In such an example, each pin may operate at dock rates of 133 MHz. Thus the CPU line 308 has bandwitdh of:

133 MHz*(1 bit,full-duplex/pin)*32 pins=4.256 Gbps, full-duplex

Additional connectors coupled to the arbiter 300 are a feedback line 310, and two POS interfaces 312 314. The four requesters, i.e., the CPU line 308, the feedback line 310, and the two POS connections 312 314, all vie via the switcher 300 for access to the LVDS Stack Bus 302. A fair weighted arbitration scheme is implemented by inclusion of an arbiter 316, in the switcher 300. Internally, the arbiter 316 includes four requestors, Requester₀, Requester₁, Requester₂, Requester₃, which grant access to the stack bus 302. The requesters are prioritized; by way of non-limiting example, they may be prioritized in descedning order, represented in pseudo code as follows:

TABLE 2

If Requester ₀ then Grant(Requester ₀)

Else if Requester ₁ then Grant(Requester ₁)

Else if Requester ₂ then Grant(Requester ₂)

Else if Requester ₃ then Grant(Requester ₃)

The switcher 300 includes an internal mux, which remaps the four connectors, i.e., the CPU controller, the POS interfaces, and the feedback line to the requesters after each grant, such that the last connector to receive a grant is mapped to Requester₃, and the remaining connectors are remapped to Requester₀, Requester₁, and Requester₂ to preserve their relative order of priority.

1. A switcher used to arbitrate between a plurality of signals coupled to the switcher, the switcher comprising:
a computational resource coupled to the switcher, such that the switcher to the plurality of signals;
a plurality of request lines, wherein the plurality of request lines govern access to the computational resource, such that the plurality of request lines are in fixed order of priority;
a multiplexer coupling the plurality of request lines to the plurality of signals, such that the multiplexer periodically remaps the plurality of signals to the plurality of requests lines to reprioritize the plurality of signals with respect to access to the computational resource.

2. The switcher of claim 1, wherein a number of signals equals a number of request lines.

3. The switcher of claim 1, wherein the computational resource is a hardware resource.

4. The switcher of claim 1, wherein the hardware resource is a bus.

5. The switcher of claim 1, wherein the hardware resource is a memory controller.

6. The switcher of claim 1, wherein the switcher is resident on programmable hardware.

7. The switcher of claim 6, wherein the programmable hardware comprises one or more FPGAs.

8. The switcher of claim 7, wherein the switcher is encoded in the FPGA in VHDL.

9. The switcher of claim 7, wherein the switcher is encoded in the FPGA in Verilog.

10. The switcher of claim 1, wherein the switcher is resident on a single ASIC.

11. The switcher of claim 1, wherein the multiplexer remaps the plurality of signals to the plurality of request lines to ensure fair weighted access of the plurality of signals to the computational resource.

12. The switcher of claim 1, wherein the computational resource is a Low Voltage Differential Signal Bus.

13. The switcher of claim 12, wherein the plurality of signals include one or more POS interfaces.

14. The switcher of claim 13, wherein the plurality of signals include a CPU controller.

15. The switcher of claim 14, wherein the plurality of signals includes a feedback signal.

16. A method of arbitrating requests between a plurality of signals for access to a computational resource, wherein the computational resource is coupled to a plurality of request lines, such that the plurality of request lines can access the computational resource in descending order of priority, the method comprising:
mapping the plurality of signals to the plurality of request lines;
subsequent to mapping the plurality of signals, granting access to the computational resource to a first signal in the plurality of signals, such the first signal is coupled to a first request line in the plurality of request lines;
in response to granting access, remapping the plurality of signals to the plurality of request lines, such that the first signal is mapped to a lowest priority request line in the plurality of request lines.

17. The method of claim 16, wherein the first request line differs from the lowest priority request lines.

18. The method of claim 16, wherein the computational resource is a high speed bus.

19. The method of claim 16, wherein a number of signals equals a number of request lines.

20. The method of claim 19, wherein the number of signals equals four signals.

21. The method of claim 20, wherein the four signals include a CPU access line.

22. The method of claim 21, wherein the four signals include two POS lines.

23. The method of claim 22, wherein the four signals include a feedback line.

24. The method of claim 23, wherein the computational resource is a Low Voltage Differential Signaling Bus.

25. The method of claim 24, wherein the remapping is conducted in a multiplexer.
